(19) United States
(12) Patent Application Publication
(10) Pub. No.: US 2024/0161126 A1
(43) Pub. Date: May 16, 2024

(54) METHODS AND APPARATUS FOR DLT-ENABLED DIGITIZED TOKENS FOR CARBON CREDITS

(71) Applicant: Dynamis Energy, LLC, Eagle, ID (US)

(72) Inventors: Robert W. Abbott, Boise, ID (US); Kevin W. Malloy, Caldwell, ID (US); Kevin McNulty, Houston, TX (US)

(73) Assignee: Dynamis Energy, LLC, Eagle, ID (US)

(21) Appl. No.: 18/416,181

(22) Filed: Jan. 18, 2024

Related U.S. Application Data
(63) Continuation-in-part of application No. 18/099,284, filed on Jan. 20, 2023.
(60) Provisional application No. 63/301,154, filed on Jan. 20, 2022.

(51) Int. Cl. G06Q 30/018; G06Q 20/02

(52) U.S. Cl. CPC G06Q 30/018; G06Q 20/02; G06Q 2220/00

(57) ABSTRACT

Disclosed embodiments include methods and computer-implemented distributed ledger technology (“DLT”) systems based at least in part upon energy usage and savings. Disclosed embodiments include instructions to cause at least one server device and related data processing and storage apparatus to operate over a peer-to-peer network to provide a system having a carbon tracker module that records a transaction comprising an amount of energy incoming from a power grid or an amount of energy savings from energy savings equipment, along with the environmental and other attributes of such energy, wherein the transaction includes identifying data and the carbon tracker module sends such data to a DLT network after verification and validation utilizing AI and/or ML, and wherein the DLT network comprises a plurality of nodes that execute a software verification algorithm that includes a cryptographic hash value based at least in part upon transaction identifying data. Disclosed embodiments also include a predictive analytics module to compare the incoming energy savings or usage against the amount of energy savings or usage from the energy equipment, a timer module to monitor the carbon tracker module through a defined term, and an invoice module for trading carbon credits through the defined term.

### CROSS-REFERENCE TO RELATED APPLICATIONS

This application is a continuation-in-part of application Ser. No. 18/099,284, filed Jan. 20, 2021, and entitled “Methods And Apparatus For DLT-Enabled Digitized Tokens For Baseline Energy Usage” the contents of which are hereby incorporated by reference herein.

### FIELD OF THE DISCLOSURE

This disclosure relates generally to verifying, validating, tracking, and trading carbon credits utilizing smart meter technology tied into a distributed ledger systems and methods. More particularly, this disclosure relates to systems and methods for the creation, tracking, and redeeming of digitized tokens related to carbon credits created through the metering of renewable electricity generation, energy efficiency savings, or the metering of clean or renewable fuels such as renewable diesel, renewable natural gas, or hydrogen

### BACKGROUND

A distributed ledger (also referred to herein as a shared ledger or distributed ledger technology or DLT) is a consensus of replicated, shared, and synchronized digital data geographically spread across multiple sites, countries, or institutions. Typically, there is no central administrator or centralized data storage.

A distributed ledger database may be spread across several nodes (e.g., devices) on a peer-to-peer network, where each node replicates and saves an identical copy of the ledger and updates itself independently. One advantage is the lack of central authority. When a ledger update happens, each node constructs the new transaction, and then the nodes vote by consensus algorithm on which copy is correct. Once a consensus has been determined, all the other nodes update themselves with the new, correct copy of the ledger. Security is typically accomplished through cryptographic keys and signatures.

A peer-to-peer network is typically required as well as consensus algorithms to ensure replication across nodes is undertaken. One form of distributed ledger design is the blockchain system, which can be either public or private.

Generally, a blockchain is a decentralized, distributed, and oftentimes public, digital ledger that is used to record transactions across many computers so that any involved record cannot be altered retroactively, without the alteration of all subsequent blocks. This allows the participants to verify and audit transactions independently and relatively inexpensively.

A blockchain database is managed autonomously using a peer-to-peer network and a distributed timestamping server. Such a design facilitates robust workflow where participants' uncertainty regarding data security is marginal. The use of a blockchain removes the characteristic of infinite reproducibility from a digital asset. It confirms that each unit of value was transferred only once, solving the long-standing problem of double spending. A blockchain has been described as a value-exchange protocol. A blockchain can maintain title rights because, when properly set up to detail the exchange agreement, it provides a record that compels offer and acceptance. Other forms, functionalities, and types of distributed ledgers, blockchains, and the like, also exist.

Additionally, more entities and industries are focused on using carbon credits and carbon offsets to compensate for other carbon dioxide (CO₂) or other greenhouse gas emissions. Typically, carbon credits are marketable permits that each reflect one metric ton, or other amount, of CO₂ or other greenhouse gas emissions that a business or other entity is allowed to emit. Carbon credits are commonly used in the context of emissions trading in which companies are given a fixed amount of credits depending on their emissions. They can later purchase more credits or sell their extra. Similarly, carbon offsets are typically created when companies, individuals, or other entities finance projects that reduce CO₂ or greenhouse gas emissions elsewhere. As used herein carbon credits and carbon offsets are used interchangeably to mean substantially the same thing—a mechanism to compensate for CO₂ or other greenhouse gas emissions.

However, with existing systems and methods it is often difficult to get accurate and real-time information relating to carbon credits. Often, emissions are merely estimated, aggregated, or otherwise represented by projected values. Likewise, issues exist with present systems and methods to ensure that carbon credit data is accurate and valid. Furthermore, inconveniences and issues exist with present systems and methods of monetizing and trading carbon credits. Other issues, drawbacks, and inconveniences with present systems and methods also exist.

### SUMMARY

Accordingly, disclosed systems and methods address the above and other issues, drawbacks, and inconveniences with present systems and methods. Disclosed embodiments for energy production and usage, whether through electricity, liquid, or gaseous fuels, can be confirmed through meters that read the data as it is produced. Other attributes of the energy produced, such as the form of production (e.g., solar, wind, biomass, hydroelectric, coal, or gas for electricity, or renewable natural gas, or diesel for fuels, and the like) or from energy savings can also be determined through the use of smart meters. Alternatively, in some embodiments a device can be installed on an existing meter to collect data without removing or affecting the meter for use by a utility for billing or tracking. This data can be used to verify and validate the creation of carbon credits or carbon offsets associated with such energy. Furthermore, this data created can be further confirmed by using other data sources and artificial intelligence (AI) to confirm the ongoing validity of the data by, for example, checking solar energy production with data indicating the regional solar insolation, or checking the constituents of a fuel to confirm that such constituents match those of the appropriate characteristics of such renewable fuel. The data can then be used to tokenize and track the carbon credits created and provide a value for such carbon credits.

Disclosed embodiments are for tracking the generation and consumption of energy in a facility, whether electricity or fuel, via systems that provide for physical reading of the actual amount of energy that is generated and/or consumed (e.g., in kilowatt hours (“kWh”), or other measurable property, unit, or metric of electricity or fuel sources), carbon intensity, etc., or its calorific value (e.g., MMBtu/second), on site. These values then can be directly compared to the expected generation or consumption of energy from the equipment installed at the related facility (by repair, replacement, addition, etc.) with the energy that would have been expected to be generated or consumed from such equipment otherwise by comparing with data from other sources, substantially improving the precision and reducing the timing required to verify or validate the creation or use of the related carbon credits or offsets. After the information from a meter reading device is thus verified and validated utilizing AI and machine learning (ML) algorithms to confirm the validity of the carbon credit, it is then transmitted to a DLT using a smart contract. Thus, the actual usage from or into a facility, or into various equipment in portions of the facility, is metered to confirm the generation, provenance, and/or usage of such energy. In other exemplary embodiments, if facility equipment is modified, such as lighting, or replaced, such as air conditioning (or other HVAC systems), the specifications of the changes in lighting or air conditioning can be included in the system database to calculate the savings that occurs from these changes operating over a time frame, and, thus, verify the creation of a carbon credit consistent with the rules of the appropriate carbon credit or offset market.

Therefore, the actual energy savings or energy production from equipment used to produce renewable energy or promote energy savings is verified on a real-time basis, and the value of the carbon credit created at the facility are then transferred as data to the distributed ledger to verify the credit. Such energy can then be tracked recorded as immutable data in the DLT, creating the basis for the further tracking of the carbon credit or offset.

Additionally, the disclosed systems and methods may implement smart contracts. Smart contracts are programs stored on a blockchain that run when predetermined conditions are met. They typically are used to automate the execution of an agreement so that all participants can be immediately certain of the outcome, without any intermediary's involvement or time loss. In some embodiments, a smart contract tied to the DLT automatically authorizes payments to the client for the purchase of carbon credits or offsets created based on the determination of buyers and sellers of such credits either through direct interactions or system auctions held by the sellers of such carbon credits or offsets. The value of the carbon credits or offsets will be based on the energy saved or generated based on the reporting tied to the credits and other benefits associated with the energy usage. Therefore, utilizing the proposed tracking of such carbon credits or offsets is easier to administer and trade.

The tracking and sale of such carbon credits or offsets is facilitated by tokenization of the data and creating a value that can be calculated as 1 metric ton of CO₂ equivalent as the basis for tracking or trading. Though the associated metering device is used to accurately track and store additional data about the carbon credits or offsets, the tokenization allows for clarity in the trading and use of such carbon credits or offsets. Thus, the energy savings or production can be tokenized to track the value created through such data related to the energy, to trade for other value, or even as collateral for monetization of the credits.

Embodiments of the disclosed systems' DLT include a data structure that stores a list of transactions and can be thought of as a distributed electronic ledger that records transactions between source (e.g., Token Generation) and destination (e.g., Token Consumption).

Embodiments of system architecture encompass Internet-of-Things (IoT) enabled smart metering devices, distributed web servers, databases, and web portals. As used herein, an “IoT enabled smart metering device” (or “module”) is responsible for collecting time-stamped data (e.g., kWh produced or consumed, renewable fuels produced, and geolocation data) from a meter and sending that data to the cloud to be validated by proprietary algorithms.

As used herein “distributed web servers” are servers used for permanent storage of validated data (history of transactions) and maintain records of carbon credits or offsets produced and consumed. Distributed web servers also maintain records of all transactions on the network (e.g., tokens used for payment of goods or services or for collateral or other transactions other than consumption of electricity).

As used herein a “web portal” is a web (internet) based user interface used to monitor the system.

The distributed web servers also continue to validate the data read by the meter from the generation source, along with the algorithms used for verifying and validating the ongoing creation of the carbon credits or offsets.

Disclosed embodiments include a computer-implemented DLT system based at least in part upon electricity and fuel usage, the system including instructions to cause at least one server device and related data processing and storage apparatus to operate over a peer-to-peer network to provide a system having a carbon tracker module that records a transaction comprising the environmental and other attributes of energy produced or consumed or saved (whether electricity or fuel), wherein the transaction includes identifying data and the carbon tracker module records and transmits such data to servers in the cloud, and wherein software verification algorithms, based at least in part upon transaction identifying data and using third party weather and other data, validate the production values. Disclosed embodiments also include a predictive analytics module utilizing AI and ML algorithms to compare the incoming carbon credits or offsets created against the expected amount of energy production or savings from the facility equipment confirmed through external sources and databases such as for weather and thereby verify and validate the carbon credit or offset, a timer module to monitor the carbon tracker module through a defined term, and an invoice module for generating an invoice for the energy saved through the defined term.

In some embodiments the carbon tracker module comprises a physical monitoring device connected to an Advanced Metering Infrastructure (AMI) meter. In still further embodiments the physical monitoring device comprises an American National Standards Institute (ANSI) certified physical monitoring device incorporating software or other programming instructions for carbon tracking.

In some embodiments the carbon tracker module communicates with the network through a cellular network connection.

In some embodiments the invoice module for generating an invoice comprises a smart contract.

Also disclosed are computer-implemented methods of operating a DLT token exchange system based at least in part upon energy usage or savings, the methods including executing instructions to cause at least one server device and related data processing and storage apparatus to operate over a peer-to-peer network to provide a method of recording, with a carbon tracker module, a transaction, wherein the transaction includes identifying data and the carbon tracker module records and transmits such data to servers in the cloud, and wherein the software verification algorithms, based at least in part upon transaction identifying data and using third party weather data, validate the production values.

In some embodiments the method also includes comparing, with a predictive analytics module utilizing AI and ML, the incoming energy usage or savings against the amount of energy usage or savings that would be expected from other sources of data that would affect the energy usage or savings such as the equipment, weather, timing, with a timer module, to monitor the carbon tracker module through a defined term.

In some embodiments of the method the carbon tracker module comprises a physical monitoring device connected to an Advanced Metering Infrastructure (AMI) meter. In further embodiments the physical monitoring device comprises an American National Standards Institute (ANSI) certified physical monitoring device.

In some embodiments of the method the carbon tracker module communicates with the network through a cellular network connection.

In some embodiments of the method the invoice module for generating an invoice comprises a smart contract.

Other embodiments also exist.

### BRIEF DESCRIPTION OF THE DRAWINGS

FIGS. 1A-1B are a schematic overview of a carbon credit DLT ecosystem in accordance with disclosed embodiments.

FIG. 2 is a schematic of utility meter in accordance with disclosed embodiments.

FIGS. 3A-3C are schematic flow and device functional diagrams illustrating carbon credit or offset creation in accordance with disclosed embodiments.

FIG. 4 is a flow chart for an exemplary method in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

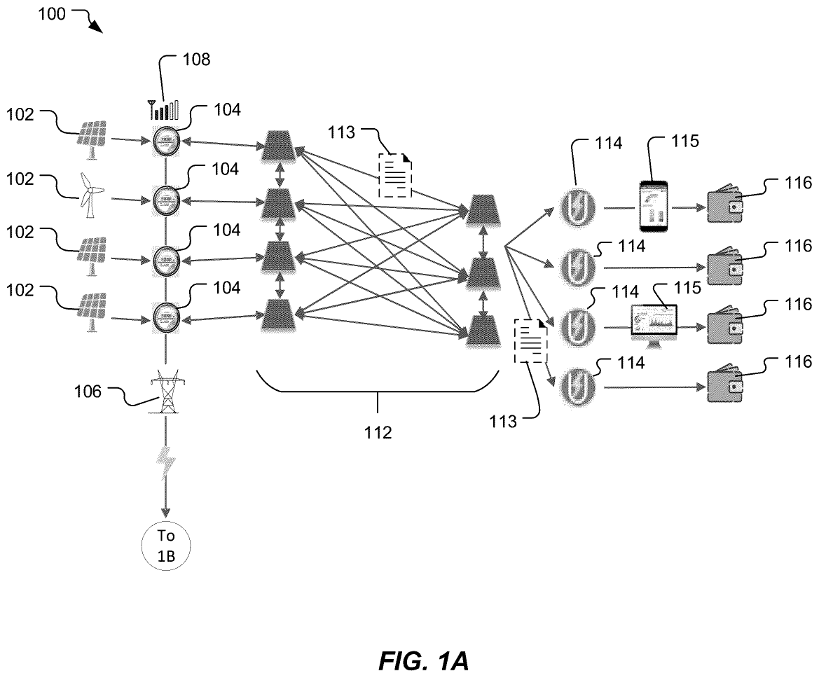

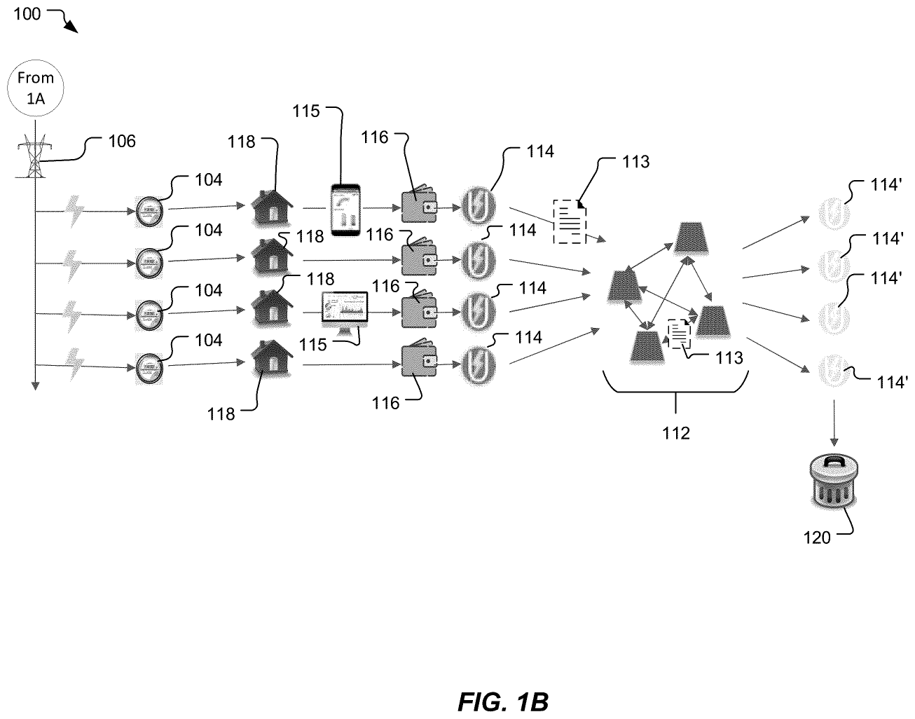

FIGS. 1A-1B are a schematic overview of a carbon credit DLT ecosystem 100 in accordance with disclosed embodiments. As illustrated, system 100 may include a number of energy generators 102 which may comprise solar, wind, hydro, waste gasifiers, nuclear, coal fired, or the like electrical generation systems.

Energy generated or saved by the equipment on site of energy generators 102 is measured by a module 104 embodiments of which may be an ANSI certified physical monitoring device connected to any standard AMI meter which monitors and stores the measurements of the amount of the energy used or saved as measured on a utility feed or interconnect line 106 by such standard AMI meter. Embodiments of module 104 may also store the time history of the energy flow through the interconnect line 106 (e.g., power grid). Embodiments of module 104 can use public or other cellular communication networks 108, or other wireless, mesh technology, Wi-Fi, or the like networks to communicate to the nodes of the system distributed ledger 112 to provide an immutable history of the generation of energy at the attached module 104 location. Geolocation is used through cellular (or other) communications networks 108 to ensure production is from the specific energy or fuel source it is tied to.

As part of the above noted validation process, embodiments of the module 104 receive calibration information from an associated energy or fuel meter as it is calibrated to ensure production of tokens 114 is not manipulated, rigged, or otherwise fraudulently created. Additionally, through the use of third-party data such as weather data, equipment production data, geolocation data, and the like analyzed with AI or ML to verify and validate the carbon credits or offsets created. The transaction is shared on the system's distributed ledger network 112. As also shown schematically, smart contracts 113 within and across DLT network 112 are used to create tokens 114 based on provable energy generation, usage, (or other energy related) data that has been validated through the use of third party data such as weather data, equipment production data, geolocation that is used with AI or ML to verify and validate the carbon credits or offsets thus created, and are the transactions that are shared to the DLT network 112. As one of ordinary skill in the art having the benefit of this disclosure would understand, “smart contracts” 113 is an industry term describing a self-executing contract with the terms of the agreement between the buyer and seller being directly written into the lines of software code. The code and the agreements contained within the smart contracts 113 exist within/across the DLT network 112. The code controls the execution, and the transaction is traceable and irreversible.

Embodiments of system 100 include one or more applications (which may be represented by a digital wallet 116) incorporated in the system 100 that allows consumers 118 and producers 102 to access the system 100 token 114 exchange. Embodiments of the system 100 application(s) can be available on any computing device 115 (i.e., smartphone, tablet, or PC, laptop, or the like) and can be used for purchase or sale of goods and services using the token 114, or the trade of tokens 114, on the basis of the underlying value of the token 114 used representing a metric ton of CO₂ equivalent (CO₂e) based on the renewable resource or energy efficiency savings. As the cost of 1 metric ton of CO₂e may vary from region to region, the system 100 also acts as an exchange to equalize the amount of tokens 114 necessary to pay for goods and services in such regions. As a result, cross-regional and cross-border trade can be fomented on the basis of a standard set around 1 metric ton of CO₂e, a definable, measurable metric. Other standards for equalizing values may also be used.

As will be apparent to those of ordinary skill in the art having the benefit of this disclosure, the system exchange stores an order book in a DLT network 112 and a plurality of digital wallets 116 associated with different clients (e.g., 118). The computer system receives new data transaction requests from the individual users modules 104 at various intervals and transactions are added to the order book in the DLT 112. This data (timestamp and transaction information) is first verified by the software verification algorithms on the network 100. If verification is successful, the transactions are added to the distributed ledger 112.

Generally, a hash is a type of algorithm that takes any input, no matter the length, and outputs a standard-length, random output. This string of characters (output) is the hash, and it is deterministic, meaning the data that is hashed will always produce the same output (string of characters). Accordingly, once a transaction refers to a prior transaction, it becomes difficult to modify or tamper with the data (e.g., the transactions) contained therein. This is because even a small modification to the data will affect the hash value of the entire transaction. Each additional transaction increases the difficulty of tampering with the contents of an earlier transaction. Thus, even though the contents of a distributed ledger (e.g., 112) may be available for all to see, they become practically immutable.

As noted, consumers 118 can purchase tokens 114 through a pre-purchase of carbon credits from an entity desiring to generate or save energy (e.g., 102). These tokens 114 can be used or exchanged with other consumers 118 for goods and services, or as collateral for other transactions. The tokens 114 can be used multiple times for multiple transactions and are only redeemed when used for a carbon credit or offset from a generator 102 within the system 100, which then takes that token 114′ out of circulation as shown at 120. Generators 102 that produce the tokens 114 may also sell or exchange the tokens 114 with other consumers 118 for goods or services. In a like manner, characteristics of the carbon credits or offsets associated with the token 114, can be traded as part and parcel of the energy, or potentially be traded separately.

In some embodiments, consumers 118 may also include modules 104 (e.g., AMI meters with modules 104) to measure their electric consumption or energy usage. This data may be stored in their digital wallet 116 and can serve as the basis for payment through tokens 114 stored on the digital wallet 116.

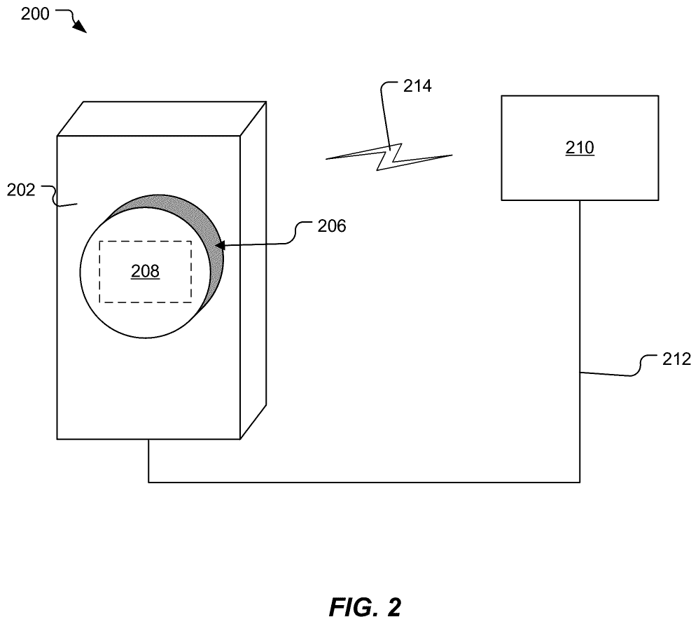

FIG. 2 is a schematic of utility meter 200 in accordance with disclosed embodiments. Embodiments of utility meter 200 may include metering equipment 202 mounted to, or near, a facility where energy consumption/creation/saving is desired to be monitored in accordance with disclosed embodiments. Other embodiments and types (e.g., digital, smart, or the like) of utility meters 200 may also be used.

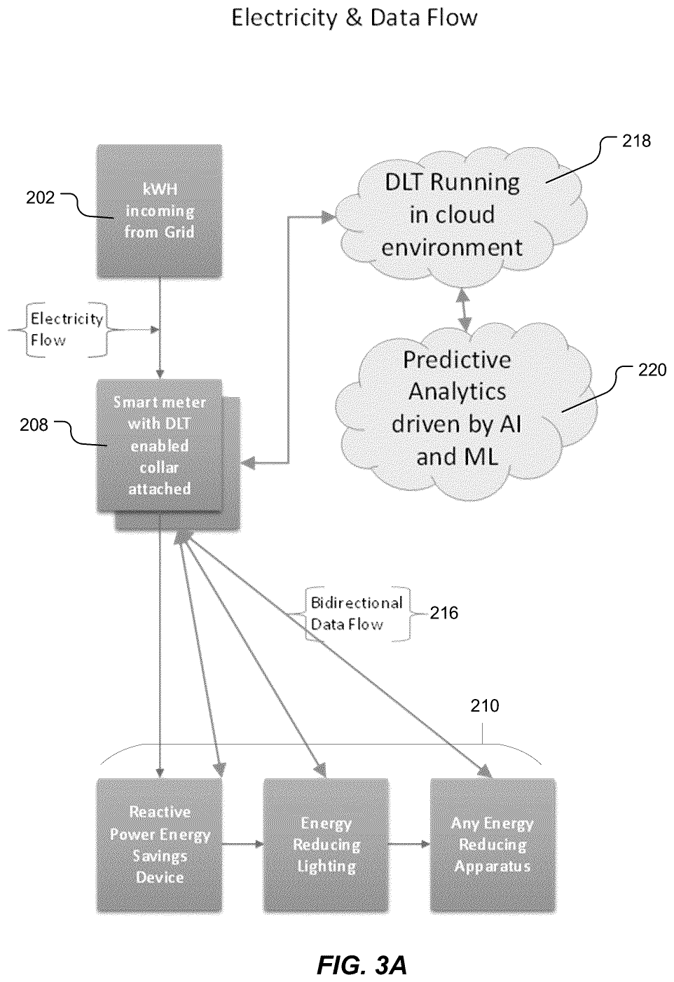

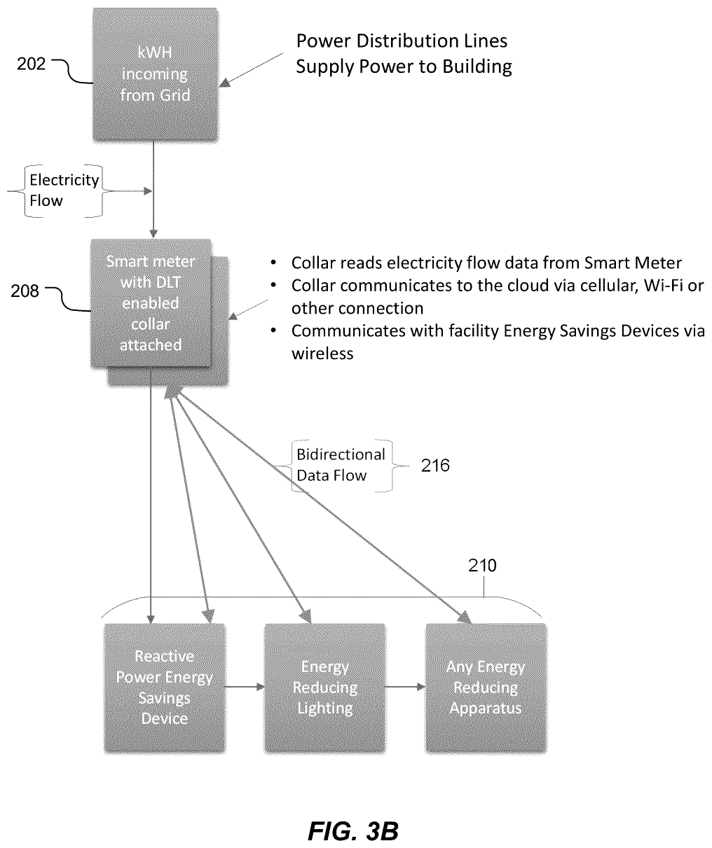

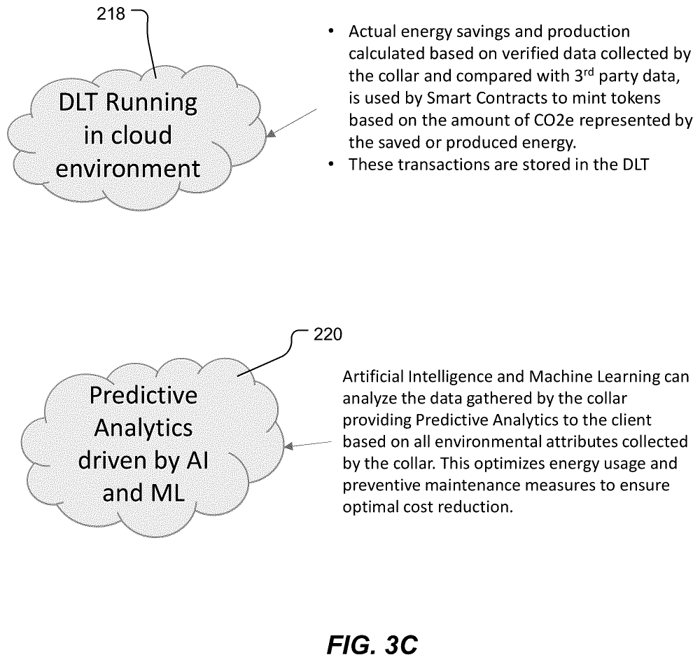

Embodiments of utility meter 200 also include a data tracking device 208 (also referred to herein as “tracker”) which includes one or more circuit boards and associated software that connect to the facility's electrical circuits 210 being monitored as part of the carbon credit tracking program in order to determine the energy usage in the equipment (including its characteristics), or sector of the building, for which the tracker 208 has been connected. Embodiments of the tracker 208 can be incorporated directly within the existing electric utility meter 200 already utilized by the utility on site (e.g., through prior permission or arrangement with the meter supplier) or attached to an existing utility meter 200 through a collar 206, or other hardware, that fits to the existing meter 200. Embodiments of collar 206 are designed to fit with any size or type of smart or other meter through standard size couplings. The tracker 208 collects the information on the energy usage or savings from the client's site and equipment installed 210 at the client's site on an ongoing basis, stores it, and then transmits it to the DLT 218 (see FIG. 3) after verification and validation utilizing AI and/or ML. Depending on the size of the facility, multiple metering devices 200 may be employed.

The tracker 208 also reads information relating to the energy produced or used in the facility, depending on the equipment 210 that is the source of use (e.g., lighting, air conditioning, refrigeration, electric vehicle charging, etc.). In some embodiments the energy savings equipment 210 installed may communicate with the tracker 208 through a wired (212) or wireless (214) system.

FIG. 3A is a schematic flow diagram illustrating electricity and data flow in accordance with disclosed embodiments. As the bi-directional data 216 is measured and collected, the data is transmitted into the tracker 208 which will then upload the data to the DLT after verification and validation utilizing AI and/or ML 218. In some embodiments the data is communicated to the cloud 218 by the tracker 208 through a cellular connection, for example, contracted with a cellular service.

The data 216 is then run through predictive analytics 220 to compare the energy usage against the calculations of the energy usage utilizing the previous installed or replaced equipment or other data from third party sources, the specifications of which may be stored also in DLT 218 in the cloud-based environment. The difference calculated between the actual energy savings or usage and the predicted energy savings or usage is then also verified and validated. This data 216 may be collected continuously through a defined term (e.g., one month), at which point the total usage or savings for such period will be determined through a smart contract 113 tied to the DLT 218, based on contract parameters. The smart contract 113 can generate and publish the data and demonstrate validation through the DLT.

As data is collected by the tracker 208 from the facility meter itself as well as directly from the energy savings devices installed, AI and machine learning algorithms 220 can then be applied to analyze the data 216 stored in the cloud 218 providing predictive analytics to the client based on all the various attributes collected by the tracker 208. This optimizes energy usage and preventive maintenance measures to ensure optimal cost reduction. FIGS. 3B-3C are schematic device functional charts related to the electricity and data flow shown in FIG. 3A and in accordance with disclosed embodiments.

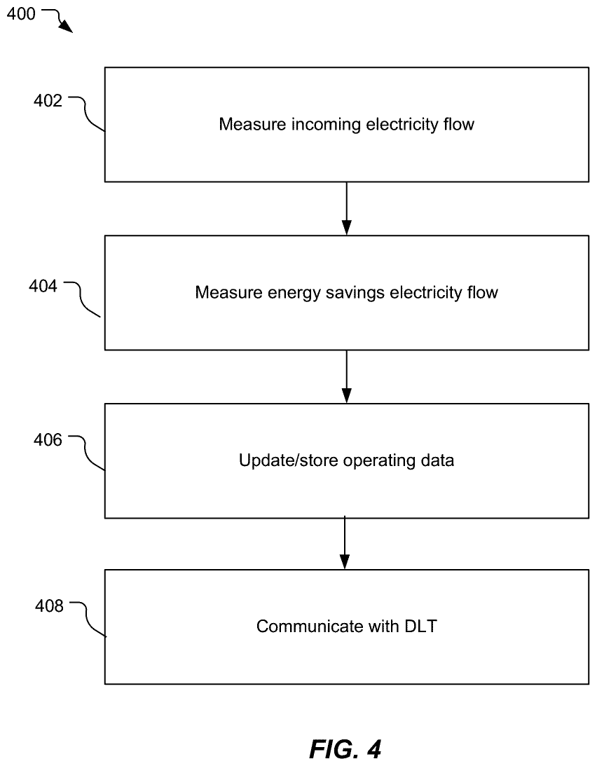

FIG. 4 is a flow chart for an exemplary method 400 in accordance with disclosed embodiments. As shown at 402 meters 200 measure energy flow into the facility, which is also read by a tracker 208. At 404 energy usage at various energy savings or generation equipment 210 installed at the site is also measured and sent to the tracker 208 by internal wireless or wired networks. At 406 operating data and specifications for the equipment modified or replaced is stored in the cloud 218. As indicated at 408 and as should be apparent from the present disclosure, each tracker 208 is a node that feeds generation and energy related data 216 through a cellular or other connection to the DLT 218, after verification and validation utilizing AI and/or ML 220, stored in the cloud.

As will be understood by those of ordinary skill in the art having the benefit of this disclosure, data 216 loss is protected from network failure by the distributed nature of the DLT 218. As disclosed herein embodiments may be cell network enabled (i.e., reliable communications that may be “always on”). Additionally, the tracker 208 is designed to be “agnostic” to the meter installation and is not tied to any particular meter type or manufacturer and can be provided with the facility utility meter 200 or retrofitted to existing smart meters. The DLT 218 is utilized to store the data needed to facilitate creation, trading and redemption of tokens that represent the actual energy usage or savings versus the predicted energy usage or savings. The smart contracts automatically process payments to the carbon credit or offset buyer based on the value of the credit calculated and the relevant parameters agreed and incorporated in the smart contract.

As also will be understood by those of ordinary skill in the art having the benefit of this disclosure, numerous applications of the disclosed systems and methods are possible. For example, in energy service or performance contracts, the energy tracking systems accurately track each block of reduced, saved or recalculated power in the immutable DLT 218 stopping disputes related to how much real power was actually saved or made available to the facility. Additionally, the tracking system can be used to accurately track and store all environmental attributes related to the power produced or saved, such as all types of global carbon credits, green energy production tax credits, green energy investment tax credits, low carbon fuel standard credits, various other local and municipality specific credits, and the like. Further, the verification of these credits through the applied DLT 218, combined with data available on the value of such credits, would allow for trading of such credits and other enhancements. Likewise, the operating characteristics of the energy savings device may also be stored in a DLT 218 along with the measured operating data to be utilized by AI and/or machine learning programs to determine when maintenance or replacement might be required. Other embodiments and application are also possible.

Although various embodiments have been shown and described, the present disclosure is not so limited and will be understood to include all such modifications and variations would be apparent to one skilled in the art.

What is claimed is:

1. A computer-implemented distributed ledger technology (“DLT”) system based at least in part upon energy usage or savings, the system comprising:
instructions to cause at least one server device and related data processing and storage apparatus to operate over a peer-to-peer network to provide a system comprising:
a carbon credit tracker module that records a transaction comprising an amount of energy incoming from a power grid and an amount of energy savings from energy savings equipment, environmental attributes, and other attributes of the amount of energy savings;
wherein the transaction includes identifying data and the carbon tracker module sends such data to a DLT network after verification and validation utilizing Artificial Intelligence (AI) and/or Machine Learning (ML); and
wherein the DLT network comprises a plurality of nodes that execute a software verification algorithm that includes a cryptographic hash value based at least in part upon transaction identifying data;
a predictive analytics module to compare the incoming electricity savings or usage against the amount of energy savings expected from the energy production or savings equipment, utilizing AI and ML algorithms applied to third party data for verification and validation of the energy generation or savings;
a timer module to monitor the carbon tracker module through a defined term; and
a pricing module for generating an value for the carbon credits or offsets through the defined term.

2. The DLT system of claim 1, wherein the cryptographic hash value is additionally based upon at least one prior verified transaction.

3. The DLT system of claim 1 wherein the carbon tracker module comprises a physical monitoring device connected to an Advanced Metering Infrastructure (AMI) meter.

4. The DLT system of claim 3 wherein the physical monitoring device comprises an American National Standards Institute (ANSI) certified physical monitoring device.

5. The DLT system of claim 1 wherein the carbon tracker module communicates with the cloud network through a cellular network connection.

6. The DLT system of claim 1 wherein the invoice module for generating an invoice comprises a smart contract.

7. A computer-implemented method of operating a distributed ledger technology (“DLT”) token exchange system based at least in part upon energy usage, the method comprising:
executing instructions to cause at least one server device and related data processing and storage apparatus to operate over a peer-to-peer network to provide a method comprising:
recording, with a carbon tracker module, a transaction comprising an amount of energy incoming from a power grid and an amount of energy savings from energy savings equipment, environmental attributes, and other attributes of the amount of energy savings;
wherein the transaction includes identifying data and the carbon tracker module sends such data to a DLT network after verification and validation utilizing Artificial Intelligence (AI) and/or Machine Learning (ML); and
wherein the DLT network comprises a plurality of nodes that execute a software verification algorithm that includes a cryptographic hash value based at least in part upon transaction identifying data;
comparing, with a predictive analytics module, the incoming energy usage or savings against the amount of energy usage savings from the energy generation or savings equipment;
timing, with a timer module, to monitor the carbon tracker module through a defined term; and
generating an invoice, with an invoice module, for the energy used or saved through the defined term.

8. The DLT method of claim 7, wherein the cryptographic hash value is additionally based upon at least one prior verified transaction.

9. The DLT method of claim 7 wherein the carbon tracker module comprises a physical monitoring device connected to an Advanced Metering Infrastructure (AMI) meter.

10. The DLT method of claim 9 wherein the physical monitoring device comprises an American National Standards Institute (ANSI) certified physical monitoring device.

11. The DLT method of claim 7 wherein the carbon tracker module communicates with the cloud network through a cellular network connection.

12. The DLT method of claim 7 wherein the invoice module for generating an invoice comprises a smart contract.
